(19) United States
(12) Patent Application Publication
(10) Pub. No.: US 2024/0237716 A1
(43) Pub. Date: Jul. 18, 2024

(54) BODY FOR AEROSOL GENERATING DEVICE AND AEROSOL GENERATING DEVICE INCLUDING THE BODY

(71) Applicant: KT&G CORPORATION, Daejeon (KR)

(72) Inventors: Won Kyeong LEE, Gyeonggi-do (KR); Jong Sub LEE, Gyeonggi-do (KR); Byung Sung CHO, Gyeonggi-do (KR)

(73) Assignee: KT&G CORPORATION, Daejeon (KR)

(21) Appl. No.: 17/928,246

(22) PCT Filed: Aug. 8, 2022
(86) PCT No.: PCT/KR2022/011758

§ 371 Date: Nov. 28, 2022

(30) Foreign Application Priority Data
Aug. 13, 2021 (KR) 10-2021-0107658
Oct. 6, 2021 (KR) 10-2021-0132695

(51) Int. Cl. A24F 40/40; A24F 40/10; A24F 40/51; A24F 40/95

(52) U.S. Cl. CPC A24F 40/40; A24F 40/10; A24F 40/51; A24F 40/95

(57) ABSTRACT

A body for an aerosol generating device includes: a housing assembly including an accommodation space for receiving at least a portion of a cartridge; a battery for supplying power to the cartridge received in the accommodation space; a first printed circuit board located inside the housing assembly; and a bracket located inside the housing assembly and supporting the first printed circuit board and the battery.

### TECHNICAL FIELD

The disclosure relates to a body for an aerosol generating device and an aerosol generating device including the body, and more particularly, to a body for an aerosol generating device that may be coupled to a cartridge, and an aerosol generating device including the body.

### BACKGROUND ART

Recently, the demand for alternative methods for overcoming the disadvantages of traditional cigarettes has increased. For example, there is growing demand for an aerosol generating device that generates an aerosol by heating or atomizing an aerosol generating material in a cigarette or a cartridge, instead of burning a cigarette.

Recently, an aerosol generating device has been suggested, including a cartridge that may store an aerosol generating material and atomize the stored aerosol generating material, and a body that may accommodate the cartridge and supply power to the accommodated cartridge.

### DISCLOSURE OF INVENTION

### Technical Problem

Regarding the aerosol generating device including the cartridge and the body, the cartridge may be separated from the body during a process of using the aerosol generating device, and as a result, damage to the cartridge may be caused or power may not be smoothly supplied to the cartridge, thereby causing a situation in which aerosol is not supplied to a user.

Accordingly, the disclosure provides a body for the aerosol generating device that may stably accommodate a cartridge and an aerosol generating device including the body, thereby preventing the cartridge from being separated from the body for the aerosol generating device during a process of using the aerosol generating device.

The technical problems of the disclosure are not limited to the above-described description, and other technical problems may be clearly understood by one of ordinary skill in the art from the embodiments to be described hereinafter.

### Solution to Problem

According to one or more embodiments, a body for an aerosol generating device includes a housing assembly including an accommodation space for receiving at least a portion of a cartridge, a battery for supplying power to the cartridge received in the accommodation space, a first printed circuit board located inside the housing assembly, and a bracket located inside the housing assembly and supporting the first printed circuit board and the battery.

According to one or more embodiments, an aerosol generating device includes a body for the aerosol generating device, and a cartridge detachably coupled to the body for an aerosol generating device, wherein the cartridge includes a reservoir in which an aerosol generating material is stored, a vibrator configured to generate vibration to atomize the aerosol generating material stored in the reservoir, and a liquid delivery element for transferring the aerosol generating material stored in the reservoir to the vibrator.

### Advantageous Effects of Invention

The body for the aerosol generating device and the aerosol generating device including the body according to the embodiments described above may prevent the cartridge from being separated from the body for the aerosol generating device.

In addition, the overall size of the body for the aerosol generating device and the aerosol generating device including the body according to the embodiments described above may be miniaturized while securing an arrangement space for components for driving the aerosol generating device.

In addition, the body for the aerosol generating device and the aerosol generating device including the body according to the embodiments described above may prevent the internal temperature of the body for the aerosol generating device from rapidly increasing.

However, effects of the embodiments are not limited to the above effects, and effects that are not mentioned could be clearly understood by one of ordinary skill in the art from the present specification and the attached drawings.

### BRIEF DESCRIPTION OF DRAWINGS

FIG. 1 is a diagram schematically illustrating an aerosol generating device according to an embodiment.

FIG. 2 is a perspective view of an aerosol generating apparatus according to an embodiment.

FIG. 3A is a perspective view of a mouthpiece of a cartridge shown in FIG. 2 placed in a first position.

FIG. 3B is a perspective view of the mouthpiece of the cartridge shown in FIG. 2 placed in a second position.

FIG. 4 is an exploded perspective view of a body for the aerosol generating device shown in FIG. 2.

FIG. 5 is a diagram of some components of the body for the aerosol generating device shown in FIG. 4.

FIG. 6 is an exploded perspective view of an inner housing of a body for an aerosol generating device and components arranged in the inner housing, according to an embodiment.

FIG. 7 is an exploded perspective view of a first housing and the components arranged around the first housing of the body for the aerosol generating device shown in FIG. 6.

FIG. 8 is an exploded perspective view of a second housing and the components arranged around the second housing of the body for the aerosol generating device shown in FIG. 6.

FIG. 9 is a diagram for explaining a combination relationship of a bracket, a first printed circuit board, and a guide member in a body for an aerosol generating device according to an embodiment.

FIG. 10 is an enlarged view of part A of the body for the aerosol generating device of FIG. 9.

FIG. 11 is a block diagram of an aerosol generating device according to another embodiment.

### MODE FOR THE INVENTION

With respect to the terms used to describe the various embodiments, general terms which are currently and widely used are selected in consideration of functions of structural components in the various embodiments of the present disclosure. However, meanings of the terms can be changed according to intention, a judicial precedence, the appearance of new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated components but not the exclusion of any other components. In addition, the terms “-er”, “-or”, and “module” described in the specification mean units for processing at least one function and operation and can be implemented by hardware components or software components and combinations thereof.

As used herein, when an expression such as “at least any one” precedes arranged elements, it modifies all elements rather than each arranged element. For example, the expression “at least one of a, b, and c” indicates only a, only b, only c, both a and b, both a and c, both b and c, all of a, b, and c, or variations thereof.

In an embodiment, an aerosol generating device may be a device that generates aerosols using a cartridge containing an aerosol generating material.

The aerosol generating device may include a cartridge containing an aerosol generating material and a body that supports the cartridge. The cartridge may be detachably coupled to the body, but embodiments are not limited thereto. The cartridge may be formed to be integrated or assembled with the body, and may be fixed to the body so that it is not removed by the user. The cartridge may be coupled to the body in a state in which the aerosol generating material is accommodated therein. However, embodiments are not limited thereto, and the aerosol generating material may be injected into the cartridge in a state in which the cartridge is coupled to the body.

The cartridge may contain an aerosol generating material in any one of various states such as a liquid state, a solid state, a gaseous state, or a gel state. The aerosol generating material may include a liquid composition. For example, the liquid composition may be a liquid including a tobacco-containing material including a volatile tobacco flavor component, or may be a liquid including a non-tobacco material.

The cartridge may be operated by an electrical signal or a wireless signal transmitted from the body to perform a function of generating aerosol by converting the phase of the aerosol generating material inside the cartridge to a gaseous phase. In the present disclosure, an “aerosol” may mean gas in a state in which vaporized particles generated from an aerosol generating material and the air are mixed with each other.

For example, the aerosol generating material may be a device for generating aerosol from the aerosol generating material by using an ultrasonic vibration method. The ultrasonic vibration method may refer to a method of generating aerosol by atomizing an aerosol generating material with ultrasonic vibration generated by a vibrator.

The aerosol generating device may include a vibrator, and the vibrator may generate vibrations of short periods to atomize the aerosol generating material. The vibration generated in the vibrator may be ultrasonic vibration, and the frequency band of the ultrasound vibration may be about 100 kHz to about 3.5 MHz, but is not limited thereto.

The aerosol generating device may further include a wick that absorbs the aerosol generating material. For example, the wick may be arranged to wrap at least one area of the vibrator or to be in contact with at least one area of the vibrator.

As the voltage (e.g., AC voltage) is applied to the vibrator, heat and/or ultrasonic vibration may be generated from the vibrator, and the heat and/or ultrasonic vibration generated from the vibrator may be transmitted to the aerosol generating material absorbed into the wick. The aerosol generating material absorbed into the wick may be converted to a gas phase by heat and/or ultrasonic vibration transmitted from the vibrator, and as a result, aerosol may be generated.

For example, the viscosity of the aerosol generating material absorbed into the wick by the heat generated from the vibrator may be lowered, and the aerosol generating material of which the viscosity is lowered by the ultrasonic vibration generated from the vibrator may be divided into fine particles, thereby generating aerosol, but embodiments are not limited thereto.

In another embodiment, the aerosol generating device may further include a cradle.

The aerosol generating device may constitute a system with a separate cradle. For example, the cradle may be used to charge the battery of the aerosol generating device. Alternatively, the heater may be heated when the cradle is coupled to the aerosol generating device.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in the aerosol generating devices of various embodiments described above, or may be implemented in various different forms, and is not limited to the embodiments described herein.

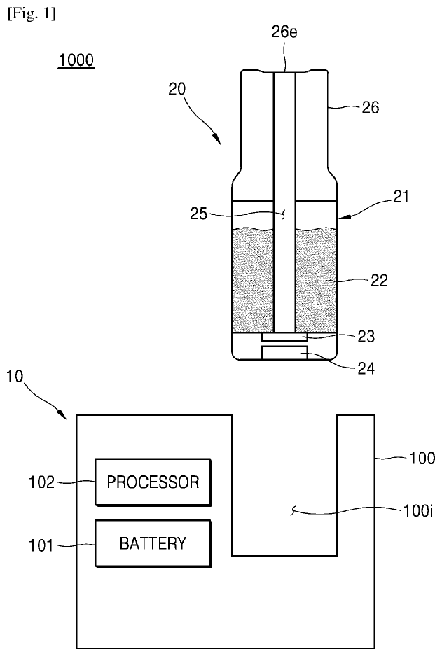

FIG. 1 is a diagram schematically illustrating an aerosol generating device according to an embodiment.

Referring to FIG. 1, the aerosol generating device 1000 according to an embodiment may include a body 10 and a cartridge 20 detachably coupled to the body 10.

According to an embodiment, the body 10 (or “body for the aerosol generating device”) may include a housing assembly 100, a battery 101, and a processor 102. The components of the body 10 are not limited to the embodiments described above, and depending on the embodiment, at least one component may be added to the body 10 or at least one component may be omitted.

The housing assembly 100 may constitute an overall appearance of the body 10, and may include accommodation space 100i to which at least a portion of the cartridge 20 may be inserted. For example, the cartridge 20 may be coupled to the body 10 by being inserted into the accommodation space 100i. The body 10 and the cartridge 20 may be coupled to each other by at least one of a snap-fit method, a screw connection method, a magnetic force coupling method, or a forcible fitting method, but a method of coupling the body 10 to the cartridge 20 is not limited to the examples described above. In another example, the cartridge 20 may be separated from the accommodation space 100i of the body 10 by an operation of the user.

The battery 101 may supply power used for the operation of the aerosol generating device 1000. For example, the battery 101 may supply predetermined power to the cartridge 20 to enable the cartridge 20 to atomize the aerosol generating material. In another example, the battery 101 may supply power necessary for the operation of other components of the aerosol generating device 1000. For example, the battery 101 may supply power necessary for the operation of the processor 102, a sensor (not shown) and/or a memory (not shown), but is not limited thereto.

The battery 101 may be a rechargeable or disposable battery. For example, the battery 101 may include a nickel-based battery (e.g., a nickel-metal hydride battery or a nickel-cadmium battery), or a lithium-based battery (e.g., a lithium-cobalt battery, a lithium-phosphate battery, a lithium titanate battery, a lithium-ion battery, or a lithium-polymer battery). However, the type of battery 101 is not limited to the embodiment described above, and depending on the embodiment, the battery 101 may include an alkaline battery or a manganese battery.

The processor 102 may control general operations of the aerosol generating device 1000. In this case, the processor 120 may be implemented as an array of a plurality of logic gates or as a combination of a general purpose microprocessor and a memory in which a program executable in the microprocessor is stored. However, the processor 102 is not limited to the embodiments described above, and may be implemented in different types of hardware depending on the embodiment.

According to an embodiment, the processor 102 may control the power supplied by the battery 101 to the cartridge 20. For example, the processor 102 may receive a user input and may control the amount of power supplied to the cartridge 20 and/or the time at which the power is supplied so that the aerosol may be generated in the cartridge 20 based on the received user input, but embodiments are not limited thereto. In another example, the processor 102 may control the amount of power supplied from the battery 101 to the cartridge 20 and/or the time at which the power is supplied based on the results sensed by the sensor (not shown).

In another embodiment, the processor 102 may detect the user's puff operation through the sensor and provide a notification to the user based on the user's puff operation. For example, the processor 102 may count the number of the user's puff operations, and when the number of puffs of the user reaches a predetermined number of time, may notify that the operation of the aerosol generating device 1000 ends to the user by using at least one of a light source, a motor and a speaker.

The cartridge 20 may include a cartridge housing 21, a reservoir 22, a liquid delivery element 23, an atomizer 24, a discharge passage 25, and a mouthpiece 26. The components of the cartridge 20 are not limited to the embodiments described above, and depending on the embodiment, at least one component may be added to the cartridge 20 or at least one component may be omitted.

The cartridge housing 21 may constitute an overall appearance of the cartridge 20, and an arrangement space in which components of the cartridge 20 may be arranged may be formed inside the cartridge housing 21. For example, the reservoir 22, the liquid delivery element 23, the atomizer 24, and the discharge passage 25 may be arranged inside the cartridge housing 21, but embodiments are not limited thereto.

The reservoir 22 may be located in an inner space of the cartridge housing 21 and may accommodate the aerosol generating material. In the present disclosure, the expression “the reservoir accommodates the aerosol generating material” means that the reservoir 22 may simply accommodate the aerosol generating material like a container, and that the reservoir 22 may include an element impregnated with (containing) an aerosol generating material, such as a sponge, cotton, fabric, or porous ceramic structure.

The reservoir 22 may accommodate an aerosol generating material having any one state of, for example, a liquid, solid, gas, gel, or the like.

According to an embodiment, the aerosol generating material may include a liquid composition. For example, the liquid composition may be a liquid including a tobacco-containing material including a volatile tobacco flavor component, or may be a liquid including a non-tobacco material.

For example, the liquid composition may include any one component of water, solvents, ethanol, plant extracts, spice, flavoring, and vitamin mixtures, or a mixture of these components. The spices may include, but is not limited to, menthol, peppermint, spearmint oil, various fruit flavoring ingredients, or the like, but is not limited thereto. The flavoring agent may include ingredients capable of providing the user with a variety of flavors or savors. Vitamin mixtures may be a mixture of at least one of vitamin A, vitamin B, vitamin C, and vitamin E, but are not limited thereto. In addition, the liquid composition may include an aerosol forming agent such as glycerin and propylene glycol.

For example, the liquid composition may include a solution of glycerin or propylene glycol in any weight ratio, to which a nicotine salt has been added. The liquid composition may include two or more types of nicotine salts. The nicotine salt may be formed by adding, to nicotine, a suitable acid including organic or inorganic acid. The nicotine is naturally occurring nicotine or synthetic nicotine and may have any suitable weight concentration relative to the total solution weight of the liquid composition.

The acid for the formation of the nicotine salts may be appropriately selected in consideration of the rate of absorption of nicotine in the blood, the operating temperature of the aerosol generating device 1000, flavor or fragrance, solubility, and the like. For example, the acid for the formation of nicotine salts may be a single acid selected from the group consisting of benzoic acid, lactic acid, salicylic acid, lauric acid, sorbic acid, levulinic acid, pyruvic acid, formic acid, acetic acid, propionic acid, butyric acid, valeric acid, caproic acid, caprylic acid, capric acid, citric acid, myristic acid, palmitic acid, stearic acid, oleic acid, linoleic acid, linolenic acid, phenylacetic acid, tartaric acid, succinic acid, fumaric acid, gluconic acid, saccharic acid, malonic acid or malic acid, or a mixture of two or more acids selected from the group, but is not limited thereto.

The liquid delivery element 23 may deliver the aerosol generating material accommodated or stored in the reservoir 22 to the atomizer 24. For example, the liquid delivery element 240 may be a wick including at least one of cotton fiber, ceramic fiber, glass fiber, or porous ceramic, but is not limited thereto.

The atomizer 24 may generate aerosol by converting the phase of the aerosol generating material. For example, the aerosol generating material stored in the reservoir 22 may be supplied to the atomizer 24 through the liquid delivery element 23, and the atomizer 24 may generate aerosol by atomizing the supplied aerosol generating material.

According to an embodiment, the atomizer 24 may change the phase of the aerosol generating material by using an ultrasonic vibration method of atomizing the aerosol generating material with ultrasonic vibration.

For example, the atomizer 24 may include a vibrator that generates a vibration of a short cycle, and the vibration generated by the vibrator may be ultrasonic vibration. The frequency of the ultrasonic vibration may be about 100 kHz to about 3.5 MHz, but is not limited thereto.

The aerosol generating material supplied to the atomizer 24 through the liquid delivery element 23 may be atomized into aerosol by being vaporized and/or divided into particles by vibration of a short cycle generated from the vibrator.

The vibrator may include, for example, a piezoelectric ceramic, which may be a functional material capable of converting an electrical force to a mechanical force and vice versa by generating electricity (e.g., a voltage) in response to a physical force (e.g., a pressure) and generating a vibration (i.e., a mechanical force) in response to electricity. That is, as electricity is applied to the vibrator, vibrations (physical force) of short periods may be generated, and the generated vibrations break down the aerosol generating material to small particles to thereby atomize to an aerosol.

According to an embodiment, the vibrator may be electrically connected to other components of the aerosol generating apparatus 1000 through an electrical connection member. For example, the vibrator may be electrically connected to the battery 101 and/or processor 102 of the main body 10 through the electrical connection member, but the components that are electrically connected to the vibrator are not limited to the examples described above. The vibrator may receive a current or a voltage from the battery 101 through an electrical connection member to generate ultrasonic vibration, or an operation thereof may be controlled by the processor 102.

The electrical connection member may include at least one of, for example, a pogo pin and a C-clip, but the electrical connection member is not limited to the examples described above. In another example, the electrical connection member may include at least one of a cable and a flexible printed circuit board (FPCB).

In another embodiment (not shown), the atomizer 24 may be implemented as a mesh shape or plate shape vibration accommodation portion that performs a function of absorbing the aerosol generating material without using a separate liquid delivery element 23 and maintaining the aerosol generating material in an optimal state for conversion to an aerosol, and a function of transmitting vibration to the aerosol generating material and generating an aerosol.

Although FIG. 1 shows that the liquid delivery element 23 and the atomizer 24 are arranged in the cartridge 20, the arrangement structure of the liquid delivery element 23 and the atomizer 24 is not limited thereto. In another embodiment, the liquid delivery element 23 may be arranged in the cartridge 20, and the atomizer 24 may be arranged in the body 10.

The discharge passage 25 may serve as a passage for the aerosol generated inside the cartridge 20 to be discharged to the outside of the cartridge 20. For example, the discharge passage 25 may be connected to or be in communication with the atomizer 24 and the outlet 26e of the mouthpiece 26, and the aerosol generated in the atomizer 24 may move along the discharge passage 25 to be discharged to the outside of the cartridge 20 through the outlet 26e.

For example, the discharge passage 25 may be wrapped by the reservoir 22 inside the cartridge 20. However, the arrangement structure of the discharge passage 25 is not limited to the example described above.

The mouthpiece 26 may be located at an area in a direction opposite to the other area coupled to the main body 10 of the cartridge 20, and may include an outlet 26e for discharging the aerosol generated in the cartridge 20 to the outside of the cartridge 20. For example, as the user's mouth becomes in contact with the mouthpiece 26 and performs a suction or puff operation, a pressure difference may occur between the outside and the inside of the cartridge 20. The aerosol generated in the cartridge 20 may be discharged to the outside of the cartridge 20 through the outlet 26e by the pressure difference between the outside and the inside of the cartridge 20. Thus, the user may inhale the aerosol discharged to the outside of the cartridge 20 through the outlet 210e of the mouthpiece 26.

In the aerosol generating device 1000, the cross-sectional shape of the aerosol generating device 1000 in a direction intersecting the lengthwise direction of the body 10 and the cartridge 20 may be approximately circular, oval, square, rectangular, or in various polygonal shapes. However, the cross-sectional shape of the aerosol generating device 1000 does not necessarily need to be limited to the shape described above, or the aerosol generating device 1000 does not necessarily need to extend in a straight line in the longitudinal direction.

In another embodiment, the cross-sectional shape of the aerosol generating device 1000 may be curved in a streamline shape for the user to comfortably hold the aerosol generating device 1000 or may be bent in a predetermined angle at a certain area and elongated, and the cross-sectional shape of the aerosol generating device 1000 may change along the longitudinal direction.

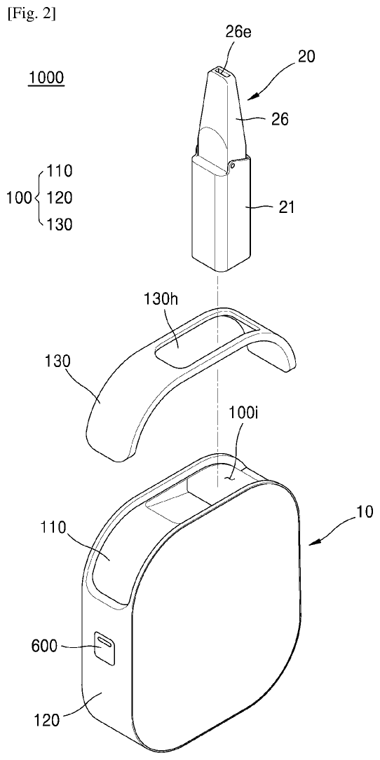

FIG. 2 is a perspective view of an aerosol generating device according to an embodiment.

Referring to FIG. 2, the aerosol generating device 1000 according to an embodiment may include the body 10 (for example, the body 10 of FIG. 1) and the cartridge 20 (for example, the cartridge 20 of FIG. 1) that may be inserted into the accommodation space 100i of the body 10. At least one of the components of the aerosol generating device 1000 according to an embodiment may be the same as or similar to at least one of the components of the aerosol generating device 1000 of FIG. 1. Hereinafter, overlapping descriptions are omitted.

The housing assembly 100 of the body 10 (or the body for the aerosol generating device) may constitute the overall appearance of the body 10, and may include the accommodation space 100i into which at least a portion of the cartridge 20 may be inserted. In an example, the housing assembly 100 may be formed overall in a pillar shape having a rectangular cross section as shown in FIG. 2, but the shape of the housing assembly 100 is not limited to the illustrated embodiment. In another example (not shown), the housing assembly 100 may be formed in a pillar shape having a circular or elliptical cross section or a pillar shape having a polygonal cross section.

According to an embodiment, the housing assembly 100 may include an inner housing 110, an outer housing 120, and a cover 130.

The inner housing 110 may provide an arrangement space (or a “mounting space”) in which the components of the aerosol generating device 1000 may be disposed. For example, in the arrangement space of the inner housing 110, the components of the aerosol generating device 1000 for operating the cartridge 20 (e.g., a battery and a processor) may be disposed, and the inner housing 110 may protect the components placed in the arrangement space.

According to an embodiment, the accommodation space 100i may be arranged in at least one area of the inner housing 110. For example, the accommodation space 100i may extend along the longitudinal direction of the inner housing 110, thereby accommodating at least a portion of the inserted cartridge 20. In this case, the accommodation space 100i may be formed to have a shape corresponding to that of the outer circumferential surface of the cartridge 20 to thereby accommodate at least a portion of the cartridge 20, but the shape of the accommodation space 100i is not limited to the illustrated embodiment.

According to an embodiment, the accommodation space 100i may be apart from the center of the inner housing 110 and arranged to be biased toward a side of the inner housing 110 such that an arrangement space for the components of the body 10 is secured, but the arrangement position of the accommodation space 100i is not limited to the embodiment described above.

The outer housing 120 may be connected or coupled to the inner housing 110, thereby forming at least a portion of the outer circumferential surface of the body 10. According to an embodiment, when the outer housing 120 is connected or coupled to the inner housing 110, the inner housing 110 and the components of the aerosol generating device 1000 arranged in the arrangement space of the inner housing 110 may be protected. For example, the outer housing 120 may be arranged to wrap at least a portion of the outer circumferential surface of the inner housing 110, thereby protecting the inner housing 110 and the components arranged in the inner housing 110, but is not limited thereto.

According to an embodiment, the outer housing 120 may include an opening 120h for exposing at least one area of the inner housing 110 to the outside of the body 10. For example, an area of the inner housing 110 in which the accommodation space 100i is located may be exposed to the outside of the body 10 through the opening 120h. Because an area of the inner housing 110 in which the accommodation space 100i is located is exposed to the outside of the body 10, the cartridge 20 may be inserted into the accommodation space 100i even when the inner housing 110 is connected or coupled to the outer housing 120.

The cover 130 may be detachably coupled to an area of the inner housing 110 exposed to the outside of the body 10 through the opening 120h of the outer housing 120, and may be attached to an area of the inner housing 110 to protect an area of the inner housing 110 exposed to the outside of the body 10. For example, the cover 130 may, through a magnetic force, be detachably coupled to an area of the inner housing 110 exposed to the outside of the body 10, but a combination method between the cover 130 and an area of the inner housing 110 is not limited to the embodiment described above.

According to an embodiment, the cover 130 may include a cover opening 130h which may be placed in a position corresponding to the accommodation space 100i of the inner housing 110. In the present disclosure, the expression “the cover opening is placed in a position corresponding to the accommodation space” may mean that the cover opening is arranged to overlap with the accommodation space or the cover opening is arranged to include an outer circumferential surface of the accommodation space.

Because the cover opening 130h is placed in a position corresponding to the accommodation space 100i, the accommodation space 100i may be exposed to the outside of the body 10 in a state in which the cover 130 is attached to an area of the inner housing 110. Because the accommodation space 100i is exposed to the outside of the body 10 even when the cover 130 is attached to an area of the inner housing 110, the cartridge 20 may be inserted into the accommodation space 100i regardless of whether the cover 130 is attached.

The body 10 for the aerosol generating device according to an embodiment may further include a button assembly 600 for receiving the user input.

According to an embodiment, the button assembly 600 may be arranged in at least one area of the outer housing 120, and the user may input the user input through the button assembly 600. For example, the user may input the user input by pressing or touching the button assembly 600 arranged on the outer circumferential surface of the body 10, and the processor of the body 10 (e.g., the processor 102 of FIG. 1) may receive the user input that is input through the button assembly 600. In this case, the processor may control the operation of the aerosol generating device 1000 based on the user input, but specific descriptions thereof are described below.

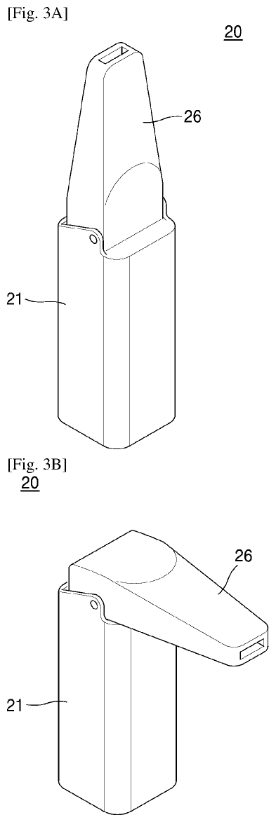

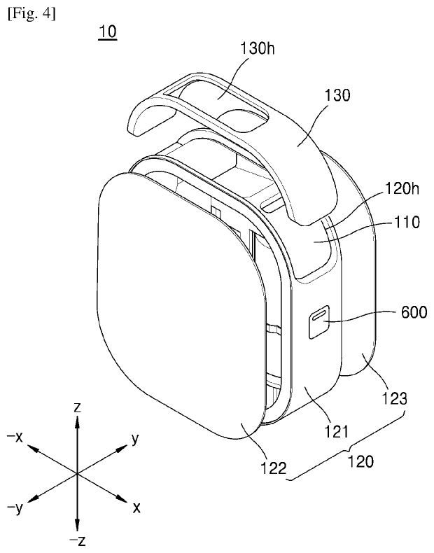

Hereinafter, with reference to FIGS. 3A and 3B, the cartridge 20, which is detachably coupled to the body 10, is described in detail.

FIG. 3A is a perspective view of the mouthpiece of the cartridge shown in FIG. 2 being located in a first position, and FIG. 3B is a perspective view of the mouthpiece of the cartridge shown in FIG. 2 being located in a second position.

Referring to FIGS. 3A and 3B, the cartridge 20 according to an embodiment may include the cartridge housing 21 (e.g., the cartridge housing 21 of FIG. 1) and the mouthpiece 26 (e.g., the mouthpiece 26 of FIG. 1). The components of the cartridge 20 according to an embodiment may be the same as or similar to at least one of the components of the cartridge 20 shown in FIG. 1. Hereinafter, overlapping descriptions are omitted.

The cartridge housing 21 may constitute the overall appearance of the cartridge 20, and the components for generating aerosol may be arranged inside the cartridge housing 21. For example, inside the cartridge housing 21, a reservoir (e.g., the reservoir 22 of FIG. 1) in which the aerosol generating material is stored, an atomizer (e.g., the atomizer 24 of FIG. 1) for atomizing the aerosol generating material to an aerosol, and a liquid delivery element (e.g., the liquid delivery element 23 of FIG. 1) for supplying the aerosol generating material stored in the reservoir to the atomizer may be included, but the components arranged inside the cartridge housing 21 are not limited thereto.

The mouthpiece 26 may be coupled to an area of the cartridge housing 21 to be movable, and may move between the first position (or “open position”) and the second position (or “closed position”) according to the operation of the user. For example, the mouthpiece 26 may be rotatably coupled to an area of the cartridge housing 21 to rotate between the first and second positions, but is not limited thereto. In another example, the mouthpiece 26 may slide between the first position and the second position.

In the present disclosure, the “first position” refers to a state in which the mouthpiece 26 is arranged in parallel with or in the same direction as the longitudinal direction of the cartridge housing 21 so that the user's mouth may easily become in contact with the mouthpiece 26, as shown in FIG. 3A.

In addition, in the present disclosure, the “second position” refers to a state in which the mouthpiece 26 is arranged in a direction crossing the longitudinal direction of the cartridge housing 21 so that the mouthpiece 26 may be accommodated or stored in the body (e.g., the body 10 of FIG. 2), as shown in FIG. 3B. For example, when the mouthpiece 26 is placed in the second position, the mouthpiece 26 may be accommodated or stored in the body 10, and thus, the area of the mouthpiece 26 being exposed to the outside of the body 10 may be minimized, and as a result, the portability of the aerosol generating device (e.g., the aerosol generating device 1000 of FIG. 2) may be improved.

That is, when the user smokes, the mouthpiece 26 may be placed in the first position so that the mouth may easily become in contact with the mouthpiece 26, and when smoking is finished, the mouthpiece 26 may be moved from the first position to the second position, thereby improving the portability of the aerosol generating device.

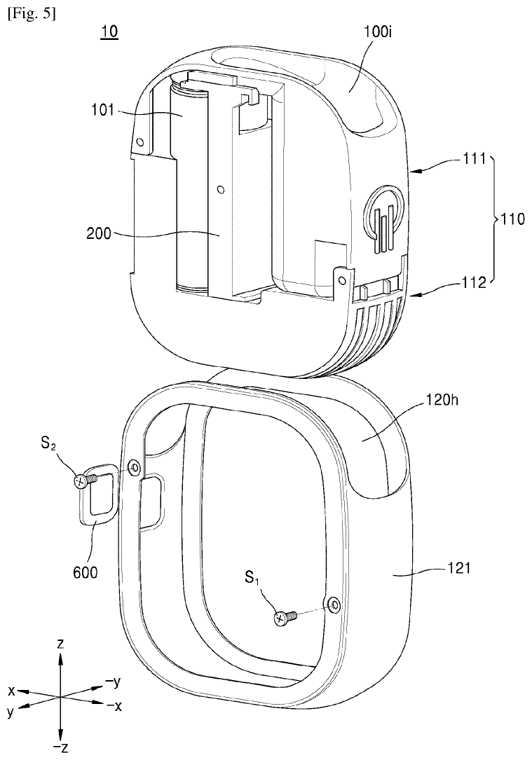

Hereinafter, the body (or “the body for the aerosol generating device”) capable of accommodating the cartridge 20 is described in detail with reference to FIGS. 4 and 5.

FIG. 4 is an exploded perspective view of the body for the aerosol generating device shown in FIG. 2, and FIG. 5 is a view showing some components of the body for the aerosol generating device shown in FIG. 4. In this case, FIG. 5 shows a view in which a second outer housing 122 and a third outer housing 123 are omitted from the body 10 of FIG. 4.

Referring to FIGS. 4 and 5, the body 10 according to an embodiment (or the “body for the aerosol generating device”) may include the inner housing 110, the outer housing 120, and the cover 130. The body 10 according to an embodiment may be applied to the aerosol generating device 1000 of FIG. 2, and overlapping descriptions are omitted.

According to an embodiment, the inner housing 110 may include a first housing 111 and a second housing 112 connected or coupled to the first housing 111.

The first housing 111 may be located at the top (e.g., the z direction of FIG. 4 or 5) of the body 10, and the accommodation space 100i into which the cartridge (e.g., the cartridge 20 of FIG. 2) may be inserted may be arranged in at least one area of the first housing 111. For example, the accommodation space 100i may be formed in a shape extending from an area facing the z direction of the first housing 111 to the −z direction of the first housing 111, but the shape and arrangement position of the accommodation space 100i is not limited to the embodiment described above.

The second housing 112 may be located at the bottom of the body 10 (e.g., the −z direction of FIG. 4 or 5), and may be connected or coupled to at least one area of the first housing 111. For example, the first housing 111 may be connected or coupled to the second housing 112 through a screw connection method, but the connection or coupling method of the first housing 111 and the second housing 112 is not limited thereto. In another example, the first housing 111 and the second housing 112 may be coupled by at least one of a snap-fit method, a magnetic force coupling method, and a fitting method.

According to an embodiment, the first housing 111 may be formed in a “┐” shape, and the second housing 112 may be formed in a “└” shape, and thus, the first housing 111 and the second housing 112 may be connected or coupled to each other. Accordingly, a space in which the components of the body 10 may be arranged may be secured between the first housing 111 and the second housing 112. However, the embodiment described above is the embodiment of the shape of the first housing 111 and the second housing 112, and the shapes of the first housing 111 and the second housing 112 are not limited to the embodiment described above.

When connecting or coupling the first housing 111 to the second housing 112, an arrangement space may be formed between the first housing 111 and the second housing 112, and the components of the body 10 may be arranged in the arrangement space. For example, the battery 101 for supplying the power to the cartridge inserted into the accommodation space 100i and a bracket 200 that supports the battery 101 may be arranged inside the arrangement space, but the components that are arranged in the arrangement space are not limited to the embodiments described above.

Although the drawings only illustrate the embodiment in which the inner housing 110 includes the first housing 111 and the second housing 112 that are separated from each other, the first housing 111 and the second housing 112 may be integrated, according to an embodiment.

The outer housing 120 may be arranged to cover at least a portion of the outer circumferential surface of the inner housing 110, and may protect the first housing 111 and the second housing 112 and the components arranged in the arrangement space between the first housing 111 and the second housing 112.

According to an embodiment, the outer housing 120 may include a first outer housing 121, a second outer housing 122, and a third outer housing 123.

The first outer housing 121 may be arranged to cover at least one area of the edges of the first housing 111 and the second housing 112 when viewed in the y or −y axis, thereby protecting the first housing 111 and the second housing 112 and the components arranged in the arrangement space between the first housing 111 and the second housing 112 from external impact or foreign matter.

According to an embodiment, the first outer housing 121 may be connected or coupled to the first housing 111 and the second housing 112, thereby covering at least one area of the edges of the first housing 111 and the second housing 112. For example, the first outer housing 121 may be connected or coupled to the first housing 111 and the second housing 112 through a first screw S₁ and a second screw S₂ by a screw connection method, as shown in FIG. 5. However, the coupling method of the first outer housing 121, the first housing 111, and the second housing 112 is not limited to the embodiment described above, and according to an embodiment, the first outer housing 121, the first housing 111, and the second housing 112 may be coupled by the snap-fit method or the magnetic force coupling method.

An opening 120h that exposes at least a portion the inner housing 110 to the outside of the body 10 may be arranged in an area of the first outer housing 121. For example, the opening 120h may be arranged in an area of the first outer housing 121 corresponding to the accommodation space 100i of the first housing 111, thereby exposing the accommodation space 100i to the outside of the body 10.

In addition, the button assembly 600 may be arranged in another area of the first outer housing 121. For example, the button assembly 600 may be arranged in an area facing the x direction of the first outer housing 121 and may be exposed to the outside of the body 10, and the user may input the user input to the button assembly 600. The processor (e.g., the processor 102 of FIG. 1) of the body 10 may control the power supply of the battery 101 based on the user input that is input through the button assembly 600, and the details thereof are described below.

The second outer housing 122 and the third outer housing 123 are connected or coupled to the first outer housing 121, thereby protecting another area of the inner housing 110 that is not covered by the first outer housing 121 from external impact and foreign matter. For example, the second outer housing 122 may be connected or coupled to the first outer housing 121 and protect the inner housing 110 that is not covered by the first outer housing 121 and area of the components arranged in the inner housing 110. In another example, the third outer housing 123 may be connected or coupled to the first outer housing 121 to face the second outer housing 122, thereby protecting the inner housing 100 that is not covered by the first outer housing 121 and the other areas of the components arranged in the inner housing 110.

According to an embodiment, the second outer housing 122 and the third outer housing 123 may be connected or coupled to the first outer housing 121 through an adhesive member (e.g., an adhesive tape), but the coupling method of the first outer housing 121, the second outer housing 122, and the third outer housing 123 is not limited thereto. According to an embodiment, the second outer housing 122 and the third outer housing 123 may be connected or coupled to the first outer housing 121 through at least one method of a screw connection method, a magnetic force coupling method, or a fitting method.

The cover 130 may be detachably coupled to an area of the inner housing 110 exposed to the outside of the body 10 through the opening 120h, thereby protecting the area of the inner housing 110. For example, the cover 130 may be detachably coupled to an area of the inner housing 110 through magnetic force coupling, and the details thereof are described below.

According to an embodiment, the cover 130 may include the cover opening 130h arranged in a position corresponding to the accommodation space 100i and/or the opening 120h of the first outer housing 121. In the present disclosure, the expression “the cover opening is placed in a position corresponding to the accommodation space and/or the opening” refers to the cover opening being arranged in a position overlapping with the accommodation space and/or the opening or in a position such that the cover opening includes the accommodation space and/or the outer circumferential surface of the opening, when viewed in the z axis.

Because the cover opening 130h is arranged at a position corresponding to the accommodation space 100i and/or the opening 120h of the first outer housing 121, the accommodation space 100i may be exposed to the outside of the body 10 even when the cover 130 is coupled to an area of the inner housing 110. Accordingly, the user may insert the cartridge into the accommodation space 100i of the body 10 even when the cover 130 is coupled to the inner housing 110.

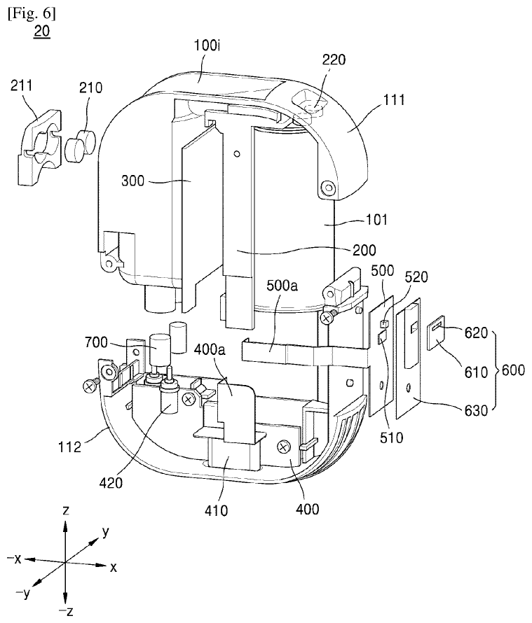

Hereinafter, with reference to FIGS. 6 to 8, details of the components of the body 10 arranged in the inner housing 110 are described below.

FIG. 6 is an exploded perspective view of the inner housing of the body for the aerosol generating device and the components arranged in the inner housing, according to an embodiment. In this case, FIG. 6 shows a state in which the outer housing 120 and the cover 130 are removed from the body 10 shown in FIG. 4 or 5.

Referring to FIG. 6, the body 10 (or the “body for the aerosol generating device”) according to an embodiment includes the battery 101, the first housing 111, the second housing 112, the bracket 200 and a first printed circuit board 300. At least one of the components of the body 10 according to an embodiment may be the same as or similar to at least one of the components of the body 10 of FIG. 5. Hereinafter, overlapping descriptions are omitted.

When the first housing 111 is coupled to the second housing 112, the battery 101 may be arranged in the arrangement space formed between the first housing 111 and the second housing 112, thereby supplying power necessary for the operation of the body 10. For example, the battery 101 may be electrically connected to the first printed circuit board 300, and may supply power necessary for the operation of the processor (e.g., processor 102 of FIG. 1) arranged in the first printed circuit board 300. In another example, when the cartridge (e.g., the cartridge 20 of FIG. 2) is inserted into the body 10, the battery 101 may be electrically connected to the inserted cartridge to supply power necessary for the operation of the atomizer (e.g., atomizer 24 of FIG. 1) of the cartridge. In another example, the battery 101 may be electrically connected to a charging module 410 through the first printed circuit board 300, thereby receiving power from an external power source connected to the charging module 410. In addition, the battery 101 may be electrically connected to a switch module 510 and/or a light source 520 to supply power necessary for the operation of the switch module 510 and/or the light source 520.

The bracket 200 may be placed in an arrangement space formed between the first housing 111 and the second housing 112, thereby supporting the battery 101 and the first printed circuit board 300. For example, the first printed circuit board 300 may be arranged on a first surface (e.g., a surface facing the −x direction) of the bracket 200, the battery may be arranged on a second surface (e.g., a surface facing the x direction) of the bracket 200, and the bracket 200 may support the first printed circuit board 300 and the battery 101 arranged on the first surface and the second surface, respectively.

That is, the bracket 200 may be located between the battery 101 and the first printed circuit board 300, thereby supporting the battery 101 and the first printed circuit board 300, and as a result, in the process of using the aerosol generating device, the positions of the battery 101 and the first printed circuit board 300 may be maintained or fixed.

The first printed circuit board 300 may include a processor (e.g., the processor 102 of FIG. 1) for controlling the components of the body 10, and may be arranged to be adjacent to the accommodation space 100i in which the cartridge is inserted. In an example, the processor may be electrically connected to the battery 101 to control the power supplied from the battery 101 to the cartridge inserted into the accommodation space 100i. In another example, the processor may be electrically connected to the switch module 510 to detect the user input through the switch module 510 and control the power supply of the battery 101 based on the user input.

According to an embodiment, the body 10 may further include a first magnet coupling portion 210, a magnet cover 211, and a second magnet coupling portion 220 for detachably connecting or coupling the cover (e.g., the cover 130 of FIG. 4) to the first housing 111.

The first magnet coupling portion 210 may include at least one magnet, and when coupling the first housing 111 to the cover, the first magnet coupling portion 210 may be arranged on an area of the first housing 111 corresponding to an area of the cover, thereby coupling the cover to the first housing 111. For example, the first magnet coupling portion 210 may be arranged in an area of the first housing 111 facing the −x direction, as shown in FIG. 6. However, the position of the first magnet coupling portion 210 is not limited to the embodiment shown above.

The magnet cover 211 may be arranged to wrap the outer circumferential surface of the first magnet coupling portion 210 to protect the first magnet coupling portion 210. Because the magnet cover 211 is arranged to cover the outer circumferential surface of the first magnet coupling portion 210, the first magnet coupling portion 210 may be covered by the magnet cover 211 such that it is not exposed to the outside of the body 10. In this case, an area of the cover may be coupled by magnetic force to the first magnet coupling portion 210 wrapped by the magnet cover 211 and may be attached to the first housing 111.

The second magnet coupling portion 220 may include at least one magnet. When the first housing 111 is coupled to the cover, the second magnet coupling portion 220 may be arranged on another area of the first housing 111 corresponding to another area of the cover, thereby coupling the cover to the first housing 111. For example, the second magnet coupling portion 220 may be arranged in another area facing the z direction of the first housing 111, but is not limited thereto. According to an embodiment, the second magnet coupling portion 220 may be arranged inside the first housing 111 which is apart by a certain distance from the first magnet coupling portion 210, and accordingly, the second magnet coupling portion 220 may be hidden by the first housing 111 and may not be exposed to the outside of the body 10. In this case, another area of the cover may be coupled by magnetic force to the second magnet coupling portion 210 arranged inside the first housing 111 and thus be attached to the first housing 111.

Although embodiments in which the first magnet coupling portion 210 and/or the second magnet coupling portion 220 include two magnets are shown in the drawings, the number of magnets of the first magnet coupling portion 210 and/or the second magnet coupling portion 220 is not limited to the illustrated embodiments.

According to an embodiment, the body 10 may further include a second printed circuit board 400, a third printed circuit board 500, and the button assembly 600. However, the components of the body 10 is not limited to the embodiments described above, and at least one of the second printed circuit board 400, the third printed circuit board 500, the button assembly 600 may be omitted in the body 10 according to another embodiment (not shown).

The second printed circuit board 400 may be arranged in an area of the second housing 112 which is apart by a certain distance from the first printed circuit board 300, and may be electrically connected to the first printed circuit board 300. For example, the second printed circuit board 400 may be located inside the second housing 112 and may be electrically connected to the first printed circuit board 300 through a first FPCB 400a through which the first printed circuit board 300 is connected to the second printed circuit board 400, but embodiments are not limited thereto. In another example, the second printed circuit board 400 may be electrically connected to the first printed circuit board 300 via a cable or C-clip.

According to an embodiment, the second printed circuit board 400 may include the charging module 410 for charging the battery 101. The charging module 410 may be exposed to the outside of the body 10 and connected to the connector of the external power source, and may charge the battery 101 through the power supplied from the external power source. For example, the charging module 410 may be connected to a USB-C type connector, a micro 5-pin type connector, or a micro 8-pin type connector of the external power source to charge the battery 101, but the charging module 410 is not limited to the embodiment described above.

According to an embodiment, the second printed circuit board 400 may further include an electrical connection member 420 that is electrically connected to the cartridge inserted into the accommodation space 100i. The electrical connection member 420 may be arranged in an area adjacent to the accommodation space 100i of the second printed circuit board 400, and thus may be electrically connected to the cartridge inserted into the accommodation space 100i. Through the electrical connection member 420, the inserted cartridge may be electrically connected to the second printed circuit board 400 and the first printed circuit board 300 electrically connected to the second printed circuit board 400. Accordingly, the processor arranged in the first printed circuit board 300 may be electrically connected to the cartridge inserted into the accommodation space 100i to control the operation of the cartridge.

In an example, the electrical connection member 420 may include a pogo pin, but the electrical connection member 420 is not limited to the embodiment described above. In another example, the electrical connection member 420 may include a C-clip or a FPCB.

The second printed circuit board 400 may be disposed in a direction crossing the first printed circuit board 300, thereby preventing the internal temperature of the body 10 from rapidly increasing. For example, the first printed circuit board 300 may be formed to extend along the z axis direction, and the second printed circuit board 400 may be formed to extend along the x axis direction, and thus, the first printed circuit board 300 may be located perpendicular to the second printed circuit board 400.

When the first printed circuit board 300 is arranged in parallel to the second printed circuit board 400, the heat generated from the components of the first printed circuit board 300 and/or the second printed circuit board 400 may accumulate, thereby rapidly increasing the internal temperature of the body 10. As a result, the internal components of the body 10 may malfunction or be damaged by heat.

In the body 10 according to an embodiment, because the first printed circuit board 300 may be arranged in a direction crossing the second printed circuit board 400, the heat generated from the components of the first printed circuit board 300 and/or the second printed circuit board 400 may be dispersed. Accordingly, the body 10 may prevent the internal temperature of the body 10 from rapidly increasing in the process of the operation of the aerosol generating device.

The third printed circuit board 500 may be arranged in an area of the second housing 112 apart by a certain distance from the first printed circuit board 300 and the second printed circuit board 400, and thus may be electrically connected to the first printed circuit board 300. For example, the third printed circuit board 500 may be arranged in an area facing the x axis direction of the second housing 112, and may be electrically connected to the first printed circuit board 300 through a second FPCB 550a connecting the first printed circuit board 300 to the third printed circuit board 500. Accordingly, the processor arranged in the first printed circuit board 300 may be electrically connected to the components of the third printed circuit board 500 (e.g., the switch module 510 and/or the light source 520). As a result, the processor may control the operation of the components of the third printed circuit board 500.

According to an embodiment, the third printed circuit board 500 may include the switch module 510 and the light source 520.

The switch module 510 may be arranged in an area facing the x direction of the third printed circuit board 500, and may detect the user input that is input through the button assembly 600. For example, the switch module 510 may include a tact switch that is electrically connected to the processor of the first printed circuit board 300, and the processor may detect the user input that is input to the button assembly 600 via the tact switch. In the present disclosure, the tact switch may refer to a switch that operates in a button manner or a key manner to generate an on signal and an off signal.

The processor may control the amount of power and/or supply time of power supplied from the battery 101 to the atomizer of the cartridge inserted into the accommodation space 100i based on the user input, but is not limited thereto.

The light source 520 may be arranged in an area facing the x direction of the third printed circuit board 500 to be adjacent to the switch module 510, and may emit light as the power is supplied from the battery 101. In this case, light emitted from the light source 520 may pass through the button assembly 600 and emit to the outside of the body 10, and the processor may control the power supplied to the light source 520 through the battery 101. For example, the processor may adjust the intensity and/or color of light emitted from the light source 520 by adjusting the amount of power and/or the supply time of power supplied to the light source 520 through the battery 101.

The light source 520 may include at least one of a light-emitting diode (LED), an organic light-emitting diode (OLED), and a polymer light-emitting diode (PLED), but the type of the light source 520 is not limited to the embodiments described above.

The button assembly 600 may be arranged in an area of the outer housing (e.g., the outer housing 120 of FIG. 4 or 5) adjacent to the third printed circuit board 500 to thereby receive the user input and emit light emitted from the light source 520 to the outside of the body 10.

According to an embodiment, the button assembly 600 may include a button portion 610, a diffusion member 620, and an elastic member 630.

The button portion 610 may be arranged on the outer circumferential surface of the outer housing and be exposed to the outside of the body 10, and the user may input the user input via the button portion 610. For example, the user input may include at least one of a touch input and a hovering input, but is not limited thereto. In the present disclosure, a “touch input” refers to an input in which the body of the user directly becomes in contact with the button portion 610, and a “hovering input” refers to an input in which the body of the user does not become in direct contact with the button portion 610 and the body of the user approaches an area adjacent the button portion 610.

The diffusion member 620 may be located between the button portion 610 and the elastic member 630, and may diffuse light emitted from the light source 520 of the third printed circuit board 500. The diffusion member 620 may reduce the illumination deviation by diffusing light emitted from the light source 520. The diffusion member 620 may include, for example, a polycarbonate (PC) that may diffuse light, but the material of the diffusion member 620 is not limited to the embodiments described above.

The elastic member 630 may be arranged to cover at least one area of the third printed circuit board 500 to protect the third printed circuit board 500, and the user input that is input to the button portion 610 may be transferred to the switch module 510 of the third printed circuit board 500. For example, if the user input is input to the button portion 610, the button portion 610 may be pressurized, and the pressure applied to the button portion 610 may be transferred to the switch module 510 through the elastic member 630.

According to an embodiment, the elastic member 630 may include at least one hole through which light emitted from the light source 520 passes through. The at least one hole may be arranged in a position corresponding to the light source 520 of the third printed circuit board 500, and light emitted from the light source 520 may pass through the at least one hole and move to the diffusion member 620.

The body 10 according to an embodiment may further include a coupling member 700 for maintaining the cartridge inserted into the accommodation space 100i inside the accommodation space 100i.

The coupling member 700 may be arranged in an area adjacent to the accommodation space 100i between the first housing 111 and the second housing 112 to thereby maintain or fix the position of the cartridge inserted into the accommodation space 100i.

In an example, the coupling member 700 may include at least one magnet that may be coupled to the cartridge inserted into the accommodation space 100i by magnetic force, but the coupling member 700 is not limited to the embodiment described above. In another example (not shown), the coupling member 700 may be located inside the accommodation space 100i, and may include a hook member that may be coupled through a snap-fit method to the cartridge inserted into the accommodation space 100i.

Thus, the body 10 according to an embodiment may maintain or fix the position of the cartridge inserted into the accommodation space 100i through the coupling member 700 to thereby prevent the cartridge from being unintentionally removed during the process of using the aerosol generating device.

In addition, the body 10 according to an embodiment may secure a space sufficient enough for the components of the body 10 to be arranged and, at the same time, miniaturize the overall size of the body 10 through the arrangement structure described above.

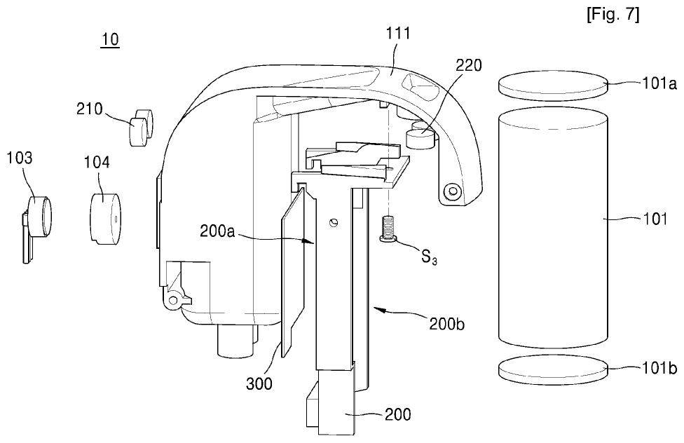

FIG. 7 is an exploded perspective view of a first housing and the components arranged around the first housing of the body for the aerosol generating device shown in FIG. 6.

Referring to FIG. 7, the battery 101, the bracket 200, the first magnet coupling portion 210, the second magnet coupling portion 220, and the first printed circuit board 300 may be arranged around the first housing 111 of the body 10 according to an embodiment. At least one of the components of the body 10 according to an embodiment may be the same as or similar to at least one of the components of the body 10 of FIG. 6. Hereinafter, overlapping descriptions are omitted.

The bracket 200 may be connected or coupled to the first housing 111, and may support the battery 101 and the first printed circuit board 300. For example, the bracket 200 may be screwed to the first housing 111 through a third screw S₃, but the method in which the bracket 200 is coupled to the first housing 111 is not limited to the embodiment described above. In another example (not shown), the first housing 111 may be coupled to the bracket 200 by a snap-fit or a magnetic force coupling method.

According to an embodiment, the bracket 200 may include a first surface 200a for supporting the first printed circuit board 300 and a second surface 200b for supporting the battery 101. For example, the first printed circuit board 300 may be arranged on the first surface 200a of the bracket 200, and the location of the first printed circuit board 300 may be maintained or fixed by the bracket 200. In another example, the battery 101 may be arranged on the second side 200b of the bracket 200, and the location of the battery 101 may be maintained or fixed by the bracket 200.

The first magnet coupling portion 210 and/or the second magnet coupling portion 220 may be coupled or fixed to the inside of the first housing 111 to thereby be coupled to the cover (e.g., the cover 130 of FIG. 4) by magnetic force. For example, the first magnet coupling portion 210 and/or the second magnet coupling portion 220 may be coupled or fixed to the inside of the first housing 111 through an adhesive or an adhesive tape, but is not limited thereto.

The body 10 according to an embodiment may further include at least one cushion member for protecting the battery 101. For example, the body 10 may include a first cushion member 101a attached or coupled to an upper end (e.g., the z direction of FIG. 6) of the battery 101 to protect the upper end area of the battery 101 and a second cushion member 101b attached or coupled to a lower end (e.g., the −z direction of FIG. 6) of the battery 101 to protect the lower end area of the battery 101. The battery 101 to which the first cushion member and/or the second cushion member is coupled may be coupled to the bracket 200 through an adhesive member (e.g., the adhesive tape), and the battery 101 may be firmly supported by the bracket 200 through the coupling structure.

The body 10 according to an embodiment may further include an air detecting sensor 103 and a protective member 104.

The air detecting sensor 103 (or “air detecting microphone”) is placed in an area adjacent to the accommodation space 100i of the first housing 111 to detect air flowing into the accommodation space 100i from the outside of the body 10. For example, the air detecting sensor 103 may be arranged to be adjacent to the accommodation space 100i to detect the flow rate and/or flow velocity of air flowing into a space between the accommodation space 100i and the cartridge inserted into the accommodation space 100i from the outside of the body 10. In this case, the air detecting sensor 103 may be electrically connected to the processor arranged on the first printed circuit board 300, and the processor may generally control the operation of the body 10 based on a result of detection of the air detecting sensor 103. For example, the processor may detect the user's puff operation or count the number of puffs based on the result of detection of the air detecting sensor 103, but is not limited thereto.

The protective member 104 may be arranged to cover at least one area of the air detecting sensor 103 to protect the air detecting sensor 103. For example, the protective member 104 may be arranged to cover the air detecting sensor 103 to prevent external foreign matter from being flown into the air detecting sensor 103. In addition, the protective member 104 may be arranged to cover the air detecting sensor 103 to thereby prevent the air detecting sensor 103 from malfunctioning or being damaged by heat generated inside the body 10. That is, in the body 10 according to an embodiment, the protective member 104 may enhance the detection result accuracy of the air detecting sensor 103.

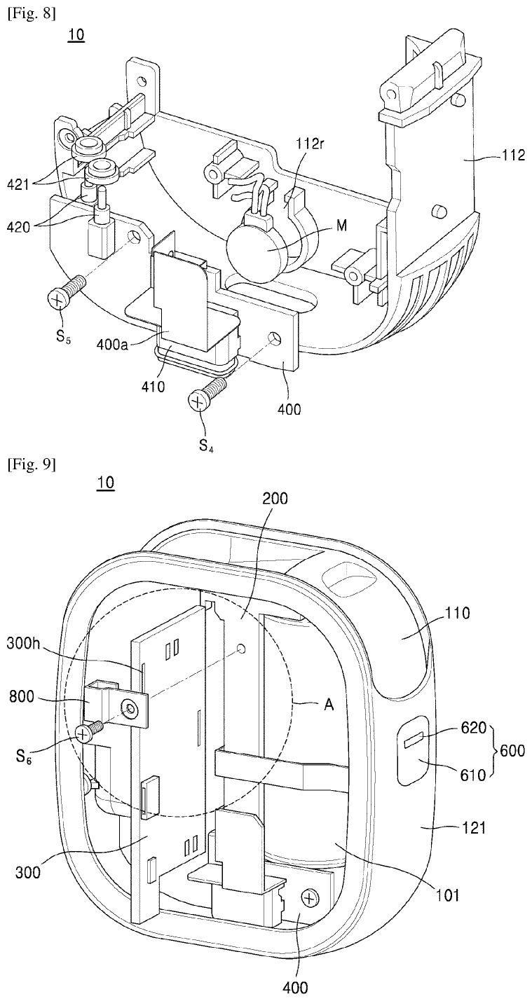

FIG. 8 is an exploded perspective view of a second housing and the components arranged around the second housing of the body for the aerosol generating device shown in FIG. 6.

Referring to FIG. 8, the second printed circuit board 400 and the motor M may be arranged around the second housing 112 of the body 10 according to an embodiment.

The second printed circuit board 400 may be connected or coupled to at least one area of the second housing 112, and may be electrically connected to the first printed circuit board (e.g., the first printed circuit board 300 of FIGS. 6 and 7) through the first FPCB 400a. For example, the second printed circuit board 400 may be coupled to the second housing 112 through the fourth screw S₄ and/or the fifth screw S₅ by a screw connection method, but the coupling method of the second housing 112 and the second printed circuit board 400 is not limited to the embodiment described above.

According to an embodiment, the second printed circuit board 400 may include the charging module 410 connected to the external power source to charge the battery (e.g., the battery 101 of FIGS. 6 and 7) of the body 10 and the electrical connection member 420 for electrically connecting the cartridge to the second printed circuit board 400.

The charging module 410 may be arranged in an area of the second printed circuit board 400, and at least a portion of the charging module 410 may be exposed to the outside of the body 10 to be connected to the connector of the external power source. For example, the charging module 410 may be connected to the USB-C type connector of the external power source, and may charge the battery through the power supplied from the external power source.

The electrical connection member 420 may be arranged in an area adjacent to the accommodation space (e.g., the accommodation space of FIGS. 6 and 7) of the second printed circuit board 400 to electrically connect the cartridge inserted into the accommodation space to the second printed circuit board 400. In an example, the electrical connection member 420 may include a pogo pin arranged to face the accommodation space, as shown in FIG. 8, and the pogo pin may be electrically connected to the cartridge inserted into the accommodation space through a hole formed in the accommodation space. In another example, the electrical connection member 420 may include at least one of the C-clip or the cable coupled to the cartridge inserted into the accommodation space, but is not limited thereto.

According to an embodiment, the body 10 may further include a fixing member 421 coupled to the electrical connection member 420. The fixing member 421 may be coupled to the electrical connection member 420 to fix the position of the electrical connection member 420. For example, the fixing member 421 may be arranged to cover the electrical connection member 420 to fix the position of the electrical connection member 420, but is not limited thereto. According to an embodiment, the body 10 may stably maintain a state in which the cartridge and the second printed circuit board 400 are electrically connected by fixing the position of the electrical connection member 420 through the fixing member 421.

The motor M may be arranged in the second housing 112 and may generate vibration through the power supplied from the battery. In an embodiment, the motor M may be accommodated in a recess 112r formed in an area of the second housing 112 and be supported by the second housing 112. In this case, the recess 112r may be formed in a shape corresponding to the outer circumferential surface of the motor M, but is not limited thereto. In addition, the motor M may be attached or coupled to the recess 112r of the second housing 112 through the adhesive member (e.g., the adhesive tape), but is not limited thereto.

According to an embodiment, the motor M may be electrically connected to the processor of the first printed circuit board, and the processor may provide a notification (or a “user notification”) to the user through the motor M. For example, when the user input is input through the button assembly, the processor may provide a notification to the user that the input is received by generating a vibration through the motor M. In another example, the processor may detect the remaining amount of battery power, and when the amount of the battery power is less than or equal to a predetermined value, the processor may provide a notification to the user that the battery needs to be charged by generating a vibration through the motor M.

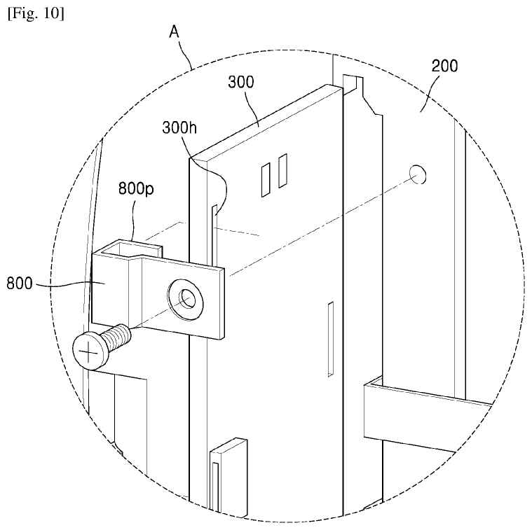

FIG. 9 is a diagram for illustrating a combination relationship between the bracket, the first printed circuit board, and the guide member in the main body for aerosol generating device according to an embodiment, and FIG. 10 is an enlarged view of part A of the body for the aerosol generating device of FIG. 9.

At least one of the components of the body 10 of FIGS. 9 and/or 10 may be the same as or similar to at least one of the components of the body 10 of FIGS. 5 and/or 6. Hereinafter, overlapping descriptions are omitted.

Referring to FIGS. 9 and 10, the body 10 (or “the body for the aerosol generating device”) according to an embodiment may include a guide member 800 for maintaining or fixing the first printed circuit board 300 on the bracket 200.

The guide member 800 may be coupled to at least one area of the bracket 200 and the position of the first printed circuit board 300 may be fixed or maintained on the first surface (e.g., the first surface 200a of FIG. 7) of the bracket 200. For example, the guide member 800 may be coupled to an area of the bracket 200 through the sixth screw S₆ through a screw connection method. In this case, the sixth screw S₆ may be fastened to one area of the bracket 200 through the guide member 800, and as a result, an area of the guide member 800 may be coupled to the one area of the bracket 200.

According to an embodiment, the guide member 800 may include a protrusion 800p coupled to a coupling hole 300h of the first printed circuit board 300. For example, the protrusion 800p of the guide member 800 may be inserted into the coupling hole 300h of the first printed circuit board 300 and fix or maintain the position of the first printed circuit board 300 on the first surface of bracket 200. In this case, the coupling hole 300h of the first printed circuit board 300 may be formed in a shape corresponding to the outer circumferential surface of the protrusion 800p of the guide member 800, thereby preventing the protrusion from moving inside the coupling hole 300h. For example, the coupling hole 300h may be formed in a polygon (e.g., rectangle) or an elliptical shape corresponding to the shape of the outer circumferential surface of the protrusion 800p, but the shape of the coupling hole 300h is not limited thereto.

The guide member 800 may be coupled to an area of the bracket 200 in a state in which the protrusion 800p is coupled to the coupling hole 300h of the first printed circuit board 300. As a result, the position of the first printed circuit board 300 may be fixed or maintained on the first surface of the bracket 200 even during the process of using the aerosol generating device.

That is, the body 10 according to an embodiment may fix or maintain the position of the first printed circuit board 300 through the guide member 800 coupled to the bracket 200 and the first printed circuit board 300. As a result, the electrical connection relationship between the first printed circuit board 300 and other components (e.g., the second printed circuit board and the third printed circuit board) may be stable during the process of using the aerosol generating device.

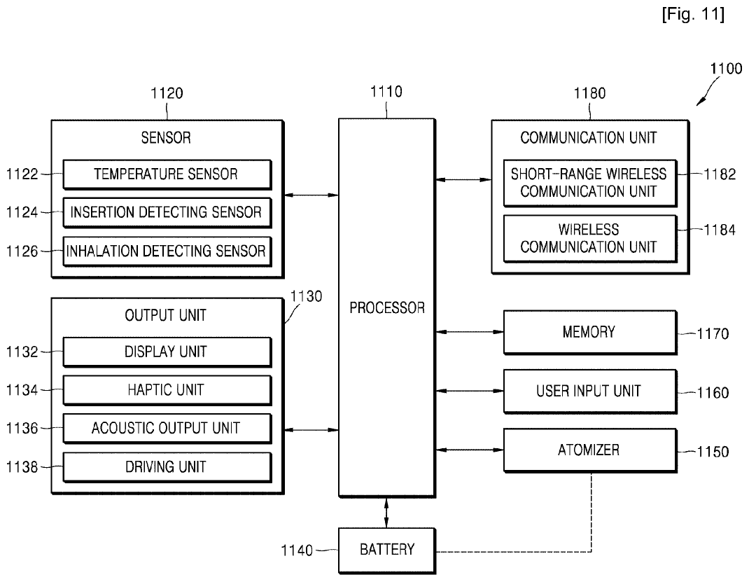

FIG. 11 is a block diagram of an aerosol generating device 1100 according to another embodiment.

The aerosol generating device 1100 may include a processor 1110, a sensing unit 1120, an output unit 1130, a battery 1140, a atomizer 1150, a user input unit 1160, a memory 1170, and a communication unit 1180. However, the internal structure of the aerosol generating device 1100 is not limited to those illustrated in FIG. 11. That is, according to the design of the aerosol generating device 1100, it will be understood by one of ordinary skill in the art that some of the components shown in FIG. 11 may be omitted or new components may be added.

The sensing unit 1120 may sense a state of the aerosol generating device 1100 and a state around the aerosol generating device 1100, and transmit sensed information to the processor 1110. Based on the sensed information, the processor 1110 may control the aerosol generating device 1100 to perform various functions, such as controlling an operation of the atomizer 1150, limiting smoking, determining whether an aerosol generating article (e.g., a cigarette, a cartridge, or the like) is inserted, displaying a notification, or the like.

The sensing unit 1120 may include at least one of a temperature sensor 1122, an insertion detection sensor, and a puff sensor 1126, but is not limited thereto.

The temperature sensor 1122 may sense a temperature at which the atomizer 1150 (or an aerosol generating material) is heated. The aerosol generating device 1100 may include a separate temperature sensor for sensing the temperature of the atomizer 1150, or the atomizer 1150 may serve as a temperature sensor. Alternatively, the temperature sensor 1122 may also be arranged around the battery 1140 to monitor the temperature of the battery 1140.

The insertion detection sensor 1124 may sense insertion and/or removal of an aerosol generating article. For example, the insertion detection sensor 1124 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 1126 may sense a user's puff on the basis of various physical changes in an airflow passage or an airflow channel. For example, the puff sensor 1126 may sense a user's puff on the basis of any one of a temperature change, a flow change, a voltage change, and a pressure change.

The sensing unit 1120 may include, in addition to the temperature sensor 1122, the insertion detection sensor 1124, and the puff sensor 1126 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 1130 may output information on a state of the aerosol generating device 1100 and provide the information to a user. The output unit 1130 may include at least one of a display unit 1132, a haptic unit 1134, and a sound output unit 1136, but is not limited thereto. When the display unit 1132 and a touch pad form a layered structure to form a touch screen, the display unit 1132 may also be used as an input device in addition to an output device.

The display unit 1132 may visually provide information about the aerosol generating device 1100 to the user. For example, information about the aerosol generating device 1100 may mean various pieces of information, such as a charging/discharging state of the battery 1140 of the aerosol generating device 1100, a preheating state of the atomizer 1150, an insertion/removal state of an aerosol generating article, or a state in which the use of the aerosol generating device 1100 is restricted (e.g., sensing of an abnormal object), or the like, and the display unit 1132 may output the information to the outside. The display unit 1132 may be, for example, a liquid crystal display panel (LCD), an organic light-emitting diode (OLED) display panel, or the like. In addition, the display unit 1132 may be in the form of a light-emitting diode (LED) light-emitting device.

The haptic unit 1134 may tactilely provide information about the aerosol generating device 1100 to the user by converting an electrical signal into a mechanical stimulus or an electrical stimulus. For example, the haptic unit 1134 may include a motor, a piezoelectric element, or an electrical stimulation device.

The sound output unit 1136 may audibly provide information about the aerosol generating device 1100 to the user. For example, the sound output unit 1136 may convert an electrical signal into a sound signal and output the same to the outside.

The battery 1140 may supply power used to operate the aerosol generating device 1100. The battery 1140 may supply power such that the atomizer 1150 may be heated. In addition, the battery 1140 may supply power required for operations of other components (e.g., the sensing unit 1120, the output unit 1130, the user input unit 1160, the memory 1170, and the communication unit 1180) in the aerosol generating device 1100. The battery 1140 may be a rechargeable battery or a disposable battery. For example, the battery 1140 may be a lithium polymer (LiPoly) battery, but is not limited thereto.

The atomizer 1150 may receive power from the battery 1140 to heat an aerosol generating material. Although not illustrated in FIG. 11, the aerosol generating device 1100 may further include a power conversion circuit (e.g., a direct current (DC)/DC converter) that converts power of the battery 1140 and supplies the same to the atomizer 1150. In addition, when the aerosol generating device 1100 generates aerosols in an induction heating method, the aerosol generating device 1100 may further include a DC/alternating current (AC) that converts DC power of the battery 1140 into AC power.

The processor 1110, the sensing unit 1120, the output unit 1130, the user input unit 1160, the memory 1170, and the communication unit 1180 may each receive power from the battery 1140 to perform a function. Although not illustrated in FIG. 11, the aerosol generating device 1100 may further include a power conversion circuit that converts power of the battery 1140 to supply the power to respective components, for example, a low dropout (LDO) circuit, or a voltage regulator circuit.

In one embodiment, the atomizer 1150 may be a heater of a resistive heating type. The heater may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome, but is not limited thereto. In addition, the heater may be implemented by a metal wire, a metal plate on which an electrically conductive track is arranged, a ceramic heating component, or the like, but is not limited thereto.

In another embodiment, the atomizer 1150 may be a heater of an induction heating type. For example, the atomizer 1150 may include a suspector that heats an aerosol generating material by generating heat through a magnetic field applied by a coil.

In another embodiment, the atomizer 1150 may be a vibrator generating ultrasonic vibration. For example, the vibrator may include a piezoelectric ceramic. As electricity is applied to the vibrator, vibrations of short periods may be generated and the generated vibrations break down the aerosol generating material to small particles to thereby atomize to an aerosol.

The user input unit 1160 may receive information input from the user or may output information to the user. For example, the user input unit 1160 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 11, the aerosol generating device 1100 may further include a connection interface, such as a universal serial bus (USB) interface, and may connect to other external devices through the connection interface, such as the USB interface, to transmit and receive information, or to charge the battery 1140.

The memory 1170 is a hardware component that stores various types of data processed in the aerosol generating device 1100, and may store data processed and data to be processed by the processor 1110. The memory 1170 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1170 may store an operation time of the aerosol generating device 1100, the maximum number of puffs, the current number of puffs, at least one temperature profile, data on a user's smoking pattern, etc.

The communication unit 1180 may include at least one component for communication with another electronic device. For example, the communication unit 1180 may include a short-range wireless communication unit 1182 and a wireless communication unit 1184.

The short-range wireless communication unit 1182 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 1184 may include a cellular network communication unit, an Internet communication unit, a computer network (e.g., local area network (LAN) or wide area network (WAN)) communication unit, or the like, but is not limited thereto. The wireless communication unit 1184 may also identify and authenticate the aerosol generating device 1100 within a communication network by using subscriber information (e.g., International Mobile Subscriber Identifier (IMSI)).

The processor 1110 may control general operations of the aerosol generating device 1100. In an embodiment, the processor 1110 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The processor 1110 may control the temperature of the atomizer 1150 or the frequency of the vibration by controlling supply of power of the battery 1140 to the atomizer 1150. For example, the processor 1110 may control power supply by controlling switching of a switching element between the battery 1140 and the atomizer 1150. In another example, a direct heating circuit may also control power supply to the atomizer 1150 according to a control command of the processor 1110.

The processor 1110 may analyze a result sensed by the sensing unit 1120 and control subsequent processes to be performed. For example, the processor 1110 may control power supplied to the atomizer 1150 to start or end an operation of the atomizer 1150 on the basis of a result sensed by the sensing unit 1120. As another example, the processor 1110 may control, based on a result sensed by the sensing unit 1120, an amount of power supplied to the atomizer 1150 and the time the power is supplied, such that the atomizer 1150 may be heated to a certain temperature or maintained at an appropriate temperature.

The processor 1110 may control the output unit 1130 on the basis of a result sensed by the sensing unit 1120. For example, when the number of puffs counted through the puff sensor 1126 reaches a preset number, the processor 1110 may notify the user that the aerosol generating device 1100 will soon be terminated through at least one of the display unit 1132, the haptic unit 1134, and the sound output unit 1136.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims. The scope of the present disclosure is defined by the appended claims rather than by the foregoing description, and all differences within the scope of equivalents thereof should be construed as being included in the present disclosure.

1. A body for an aerosol generating device comprising:
a housing assembly including an accommodation space for receiving at least a portion of a cartridge;
a battery for supplying power to the cartridge received in the accommodation space;
a first printed circuit board located inside the housing assembly; and
a bracket located inside the housing assembly and supporting the first printed circuit board and the battery.

2. The body for the aerosol generating device of claim 1, wherein the housing assembly comprises:
a first housing arranged in the accommodation space;
a second housing connected to at least one area of the first housing;
an outer housing arranged to cover at least a portion of outer circumferential surfaces of the first housing and the second housing, and including an opening exposing an area of the first housing to the outside; and
a cover detachably coupled to the area of the first housing exposed through the opening.

3. The body for the aerosol generating device of claim 2, wherein the battery, the first printed circuit board, and the bracket are arranged in an arrangement space formed between the first housing and the second housing.

4. The body for the aerosol generating device of claim 3, wherein an area of the first printed circuit board is arranged on a first surface of the bracket, and
the battery is arranged on a second surface of the bracket located opposite to the first surface.

5. The body for the aerosol generating device of claim 2, further comprising a guide member coupled to at least one area of the bracket to maintain the first printed circuit board on the bracket.

6. The body for the aerosol generating device of claim 5, wherein
the first printed circuit board includes a coupling hole, and
the guide member includes a protrusion inserted into the coupling hole.

7. The body for the aerosol generating device of claim 2, wherein the first housing comprises:
a first magnet coupling portion coupled to an area of the cover by magnetic force;
a magnet cover arranged to cover the first magnet coupling portion to protect the first magnet coupling portion; and
a second magnet coupling portion located between the first housing and the battery and coupled to another area of the cover by magnetic force.

8. The body for the aerosol generating device of claim 2, further comprising:
an air detecting sensor arranged in an area of the accommodation space of the first housing and configured to detect air flowing into the accommodation space from the outside; and
a protective member arranged to cover at least one area of the air detecting sensor and configured to protect the air detecting sensor.

9. The body for the aerosol generating device of claim 2, further comprising:
a second printed circuit board arranged in the second housing and including a charging module; and
a first flexible printed circuit board electrically connecting the first printed circuit board to the second printed circuit board.

10. The body for the aerosol generating device of claim 9, wherein the second printed circuit board comprises at least one electrical connection member to electrically connect the cartridge inserted into the accommodation space to the second printed circuit board.

11. The body for the aerosol generating device of claim 2, further comprising:
a third printed circuit board located between the outer housing and the second housing and comprising a switch module for receiving a user input and a light source for emitting light as power is supplied from the battery; and
a second flexible printed circuit board electrically connecting the first printed circuit board to the third printed circuit board.

12. The body for the aerosol generating device of claim 11, further comprising a button assembly arranged in an area of the outer housing corresponding to the third printed circuit board, wherein
the switch module receives the user input that is input to the button assembly.

13. The body for the aerosol generating device of claim 12, wherein the button assembly comprises:
a button portion arranged in at least one area of the outer housing;
an elastic member covering at least one area of the third printed circuit board and including at least one hole through which light emitted from the light source passes; and
a diffusion member located between the button portion and the elastic member and configured to diffuse light emitted from the light source.

14. The body for the aerosol generating device of claim 1, further comprising a coupling member located inside the housing assembly, and coupled to the cartridge inserted into the accommodation space to maintain the cartridge inside the accommodation space.

15. An aerosol generating device comprising:
the body for an aerosol generating device of claim 1; and
a cartridge detachably coupled to the body for an aerosol generating device, wherein
the cartridge comprises:
a reservoir in which an aerosol generating material is stored;
a vibrator configured to generate vibration to atomize the aerosol generating material stored in the reservoir; and
a liquid delivery element for transferring the aerosol generating material stored in the reservoir to the vibrator.
